(19) United States
(12) Patent Application Publication
(10) Pub. No.: US 2015/0210879 A1
(43) Pub. Date: Jul. 30, 2015

(54) LAMINATED FILM AND METHOD FOR PRODUCING THE SAME

(71) Applicant: FUJIFILM CORPORATION, Tokyo (JP)

(72) Inventor: Ryuta TAKEGAMI, Shizuoka (JP)

(73) Assignee: FUJIFILM CORPORATION, Tokyo (JP)

(21) Appl. No.: 14/683,731

(22) Filed: Apr. 10, 2015

Related U.S. Application Data
(63) Continuation of application No. PCT/JP2013/075075, filed on Sep. 18, 2013.

(30) Foreign Application Priority Data
Oct. 12, 2012 (JP) 2012-226793

(51) Int. Cl. C09D 123/08; B29C 55/14; B29C 47/00

(52) U.S. Cl. CPC C09D 123/0869; B29C 47/0057; B29C 55/143; B29K 2023/06; B29K 2033/08

(57) ABSTRACT

A laminated film containing a polyester film and a coating layer wherein the coating layer contains an acid-modified polyolefin resin and a basic compound having a boiling point of 200° C. or less, and, the polyester film contains a compound that is derived from the acid-modified polyolefin resin contained in the coating layer, can be produced by an in-line coating method. The laminated film is excellent in adhesion property and water resistance, and may be recycled and reused to suppress the cost for producing the laminated film.

### CROSS-REFERENCE TO RELATED APPLICATIONS

This application is a Continuation of PCT International Application No. PCT/JP2013/075075, filed Sep. 18, 2013, which claims priority under 35 U.S.C. Section 119(a) to Japanese Patent Application No. 2012-226793 filed on Oct. 12, 2012. Each of the above applications is hereby expressly incorporated by reference, in its entirety, into the present application.

### BACKGROUND OF THE INVENTION

1. Field of the Invention

The present invention relates to a laminated film. Specifically, the invention relates to a laminated film having a coating layer containing an acid-modified polyolefin resin and a basic compound. The invention also relates to a method for producing a laminated film.

2. Related Art

A polyester film is being applied to a wide variety of fields including aback sheet for a solar cell module, an optical film, a tracing film, a packaging film, a magnetic tape, an insulating tape and the like. In these applications, in general, a polyester film is often used as a laminated film having another film having a functionality laminated thereon. However, since a polyester film does not have adhesiveness by itself, a coating layer, such as an easily adhesive layer, is laminated on a polyester film, and the another layer is adhered through the coating layer.

The coating layer is generally formed by an off-line coating method or an in-line coating method. In particular, the in-line coating method has an advantage that the adhesion property between the polyester film and the coating layer may be enhanced. For example, Patent Documents 1 and 2 describe a method of forming a coating layer containing a polyester resin, an acrylic resin, a urethane resin or the like that has high compatibility with the polyester resin, by an in-line coating method. In the case where the in-line coating method is used, in general, the material except for that used in the film product is recovered and reused as a raw material of the film. In Patent Documents 1 and 2, the film is recycled by using a resin having high compatibility with the polyester resin.

A polyolefin resin is incompatible with a polyester resin, but is being used as a material for the coating layer due to the excellent water resistance and adhesion property thereof. For example, Patent Document 3 describes an aqueous dispersion containing a polyolefin resin, and a coating layer is formed by an off-line coating method. A metal salt as a basic compound is added to the coating solution for dispersing the water insoluble polyolefin resin in an aqueous dispersion to form an aqueous dispersion.

### PATENT DOCUMENTS

### [Patent Document 1]: JP-A-2005-178313

### [Patent Document 2]: JP-A-7-178885

### [Patent Document 3]: JP-A-2000-72879

### SUMMARY OF INVENTION

However, the laminated films described in Patent Documents 1 and 2 use a resin having high compatibility with a polyester resin in the coating layer, and thus there may be a problem that the coating layer has insufficient water resistance, and the adhesion property is lowered when the laminated film is used under high humidity condition.

Furthermore, Patent Document 3 uses a polyolefin resin having high water resistance, but a metal salt is contained in the coating layer. The metal salt may remain in the film raw material after recycling and may accelerate hydrolysis of the polyester resin, and thus there may be a problem that the recycling efficiency is significantly deteriorated when the film is recycled. Moreover, the laminated film described in Patent Document 3 is also insufficient in the adhesion property between the coating layer and the base film, and thus further improvement is demanded.

For solving the problem of the related art, the present inventors have made investigations for providing a laminated film that has a high recycling efficiency and a reduced production cost even when a coating layer containing a polyolefin resin formed on a polyester film. The inventors have further made investigations for providing a laminated film that has both water resistance and adhesion property.

As a result of earnest investigations for solving the problem, the inventors have found that a laminated film that has a high recycling efficiency and a reduced production cost may be obtained by adding an acid-modified polyolefin and a volatile basic compound having a boiling point of 200° C. or less to the coating layer.

Furthermore, the inventors have found that the coating layer containing a polyolefin resin may be formed by an in-line coating method. Accordingly, the inventors have succeeded to enhance the adhesion property between the coating layer and the polyester film of the laminated film, and to obtain the laminated film having water resistance, and thus the invention has been completed.

Specifically, the invention includes the following aspects.

[1] A laminated film containing a polyester film and a coating layer that is laminated on at least one surface of the polyester film, wherein the coating layer contains an acid-modified polyolefin resin and a basic compound having a boiling point of 200° C. or less, and, the polyester film contains a compound that is derived from the acid-modified polyolefin resin contained in the coating layer.
[2] The laminated film according to [1], wherein the compound that is derived from the acid-modified polyolefin resin is contained in an amount of from 10 to 1,000 ppm based on the mass of the polyester film.
[3] The laminated film according to [1], wherein the coating layer has a thickness of from 0.01 to 1 μm.
[4] The laminated film according to [1], wherein the acid-modified polyolefin resin has a melt flow rate at 190° C. and a load 2,160 g of from 0.01 to 500 g/10 minutes.
[5] The laminated film according to [1], wherein the acid-modified polyolefin resin contains an unsaturated carboxylic acid or an anhydride thereof in an amount of from 0.1 to 10% by mass.
[6] The laminated film according to [5], wherein the unsaturated carboxylic acid or the anhydride thereof is acrylic acid, methacrylic acid, an acrylic anhydride, or a methacrylic anhydride.
[7] The laminated film according to [1], wherein the acid-modified polyolefin resin contains an unsaturated carboxylate ester in an amount of from 0.1 to 25% by mass.
[8] The laminated film according to [7], wherein the unsaturated carboxylate ester is a methyl ester of an unsaturated carboxylic acid, an ethyl ester of an unsaturated carboxylic acid, or a butyl ester of an unsaturated carboxylic acid.
[9] The laminated film according to [1], wherein the acid-modified polyolefin resin is a terpolymer of an ethylene, an unsaturated carboxylate ester, and an unsaturated carboxylic acid; or a terpolymer of an ethylene, an unsaturated carboxylate ester, and an anhydride of an unsaturated carboxylic acid.
[10] The laminated film according to [1], wherein the acid-modified polyolefin resin is a terpolymer of an ethylene, an acrylate ester, and acrylic acid; a terpolymer of an ethylene, an acrylate ester, and an acrylic anhydride; a terpolymer of ethylene, a methacrylate ester, and acrylic acid; or a terpolymer of ethylene, a methacrylate ester, and an acrylic anhydride.
[11] The laminated film according to [1], wherein the basic compound is an ammonia or an organic amine compound.
[12] The laminated film according to [1], wherein the basic compound is contained in an amount of from 0.5 to 3.0 times by molar equivalent based on the molar number of carboxyl groups in the acid-modified polyolefin resin.
[13] The laminated film according to [1], wherein the polyester film contains a Ti compound.
[14] A method for producing a laminated film containing coating a coating solution on at least one surface of a polyester film, and stretching the resultant to form a coating layer,

wherein the coating solution contains a basic compound having a boiling point of 200° C. or less and an acid-modified polyolefin resin, and,

the polyester film contains a compound that is derived from the acid-modified polyolefin resin contained in the coating layer.

[15] The method for producing a laminated film according to [14], further containing drying before the forming of the coating layer, wherein the drying is heating a resin mixture containing a polyester resin and an acid-modified polyolefin resin.
[16] The method for producing a laminated film according to [15], wherein the resin mixture contains a recycled film.
[17] The method for producing a laminated film according to [15], wherein the resin mixture is a mixture of a recycled film and a polyester resin, and,

the recycled film is contained in an amount of from 20 to 80% by mass based on the polyester resin.

[18] The method for producing a laminated film according to [15], wherein the drying contains drying the resin mixture at from 100 to 200° C.
[19] A laminated film produced by coating a coating solution on at least one surface of a polyester film, and stretching the resultant to form a coating layer,

wherein the coating solution contains a basic compound having a boiling point of 200° C. or less and an acid-modified polyolefin resin, and,

the polyester film contains a compound that is derived from the acid-modified polyolefin resin contained in the coating layer.

According to the invention, a laminated film that is capable of being recycled and is suppressed in the production cost may be provided. According to the invention, furthermore, a coating film containing a polyolefin resin may be formed on a polyester film by an in-line coating method. Accordingly, a laminated film that has both water resistance and adhesion property may be provided.

### BRIEF DESCRIPTION OF DRAWINGS

FIG. 1 is cross sectional view showing an example of the laminated film of the invention.

FIG. 2 is a graph showing the properties of the laminated film of the invention.

### DESCRIPTION OF EMBODIMENTS

The invention will be described in detail below. The descriptions for the constitutional elements shown below may be based on representative embodiments and specific examples, but the invention is not limited to the embodiments. The numerical range herein expressed with numerical values includes the numerical values as the lower limit and the upper limit.

### Laminated Film

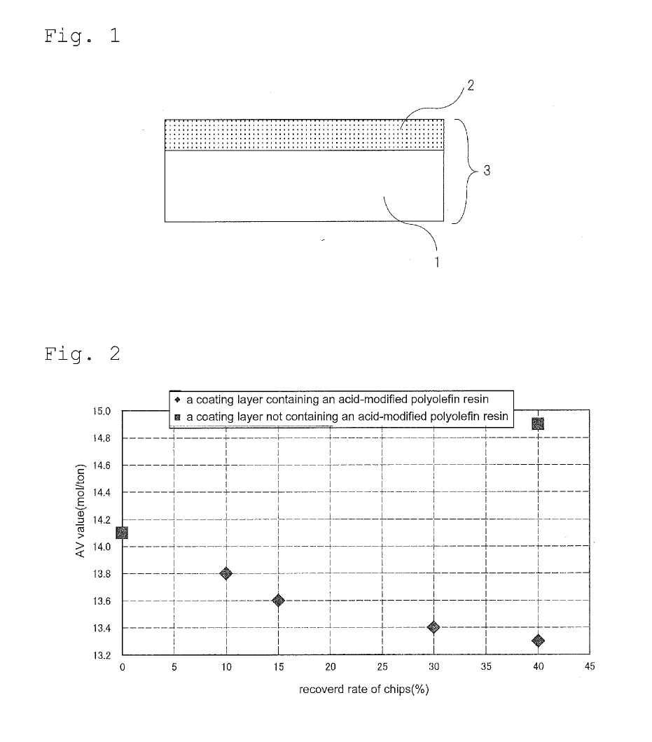

As shown in FIG. 1, the invention relates to a laminated film 3 containing a polyester film 1 and a coating layer 2 that is laminated on at least one surface of the polyester film 1. The laminated film 3 of the invention may be obtained by forming the coating layer 2 on the polyester film 1 by an in-line coating method.

The in-line coating method is a production method containing a sequence of film coating process steps including a resin extrusion step, a stretching step, a coating step, a stretching step and the like, which are performed continuously without winding the film. The in-line coating method is distinguished from the off-line coating method, which contains a film forming process steps, in which the film is wound in the course of the process steps and then subjected to a coating step.

In the in-line coating method, a stretching step is performed after a coating step. In the case where plural stretching steps are provided, the stretching step may also be performed before the coating step. In the in-line coating step, at least one stretching step is performed after the coating step. For example, after the coating step, the longitudinal stretching step is performed, and then the transverse stretching step is performed; or after the longitudinal stretching step, the coating step is performed, and then the transverse stretching step is performed. The transverse stretching step may be performed before the longitudinal stretching step, and the stretching steps each may be divided into plural steps.

The coating layer may be formed by coating a coating solution on the polyester film, and then stretching. The coating solution contains a basic compound having a boiling point of 200° C. or less and an acid-modified polyolefin resin. The coating layer thus formed contains a basic compound having a boiling point of 200° C. or less and an acid-modified polyolefin resin.

The polyester film may contain a compound that is derived from the acid-modified polyolefin resin contained in the coating layer. In general; the fact that the polyester film contains a compound that is derived from the acid-modified polyolefin resin means that the laminated film is recycled and reused. In the invention, accordingly, the polyester film contains a film raw material that is obtained by recovering and recycling a part of the laminated film.

The polyester film containing a compound that is derived from the acid-modified polyolefin resin may not be necessarily formed with a recycled raw material, but may be formed by adding separately a compound that is derived from the acid-modified polyolefin resin to the polyester film.

In the invention, the recycling efficiency of the laminated film may be enhanced, and thus the coating layer may be produced by an in-line coating method. According to the constitution, a laminated film that is excellent in adhesion property and water resistance may be obtained. In the invention, the recycling efficiency of the laminated film may be enhanced, and thus the production cost required for producing the laminated film may be largely reduced.

A release layer may be further provided on the surface of the coating layer of the laminated film. The coating layer has adhesiveness, and thus there may be cases where the exposed coating layer is adhered to an unintended article, and the coating layer itself is deteriorated. Accordingly, for protecting the coating layer physically and chemically, a release layer may be provided on the surface of the coating layer, and in use, the release layer may be released off to expose the coating layer, on which another member may be laminated.

Examples of the release layer include a releasing agent layer formed by coating a releasing agent, such as silicone, on various kinds of plastic films, and a simple polypropylene film, and those that have been ordinarily used as a release sheet for an adhesive sheet may be used.

Another functional layer may also be provided on the surface of the coating layer of the laminated film. Examples of the functional layer laminated include a hardcoat layer, an antireflection layer, an antifouling layer, an antistatic layer, and a barrier layer. According to the constitution, the laminated film of the invention may be applied to various purposes.

### Coating Layer

The coating layer herein means a matter that has a layer structure and is formed on the surface of the polyester film. The coating layer may function as an easily adhesive layer that adheres the polyester film with another functional layer.

The thickness of the coating layer is preferably from 0.01 to 1 μm. The thickness of the coating layer is preferably 0.01 μm or more, more preferably 0.03 μm or more, and further preferably 0.05 μm or more. The thickness of the coating layer is preferably 1 μm or less, more preferably 0.8 μm or less, and further preferably 0.7 μm or less. The coating layer may have a structure containing two or more layers, and in the case where the structure thereof contains two or more layers, the total thickness thereof is preferably in the aforementioned range. When the thickness of the coating layer is in the range, the coating layer that is excellent in adhesiveness and does not impair the functionality of the laminated film may be obtained.

### Acid-Modified Polyolefin

The coating layer contains an acid-modified polyolefin resin. The acid-modified polyolefin is a modified product obtained by bonding a carboxylic acid or a carboxylic anhydride to a homopolymer or a copolymer of an olefin component.

In the acid-modified polyolefin resin, while the olefin component as a major component thereof is not particularly limited, an alkene having from 2 to 6 carbon atoms, such as ethylene, propylene, isobutylene, 2-butene, 1-butene, 1-pentene and 1-hexene, is preferred, and mixtures thereof may also be used. Among these, for providing good adhesiveness, an alkene having from 2 to 4 carbon atoms, such as ethylene, propylene, isobutylene and 1-butene, is more preferably used, ethylene and propylene are further preferably used, and ethylene is most preferably used. As for ethylene, low density polyethylene having a branched structure is particularly preferably used.

The acid-modified polyolefin resin in the invention is a resin that is acid-modified with an unsaturated carboxylic acid or an anhydride thereof. Examples of the unsaturated carboxylic acid component include acrylic acid, methacrylic acid, maleic acid, maleic anhydride, itaconic acid, itaconic anhydride, fumaric acid and crotonic acid, and also include a half ester and a half amide of an unsaturated dicarboxylic acid. Among these, acrylic acid, methacrylic acid, maleic acid, and maleic anhydride are preferred, and acrylic acid and maleic anhydride are particularly preferred.

The unsaturated carboxylic acid component may be copolymerized in the acid-modified polyolefin resin with no limitation in the form thereof, and examples of the mode of copolymerization include random copolymerization, block copolymerization, and graft copolymerization (graft modification).

The content of the unsaturated carboxylic acid or an anhydride thereof in the acid-modified polyolefin resin may be from 0.1 to 10% by mass, preferably from 0.5 to 8% by mass, more preferably from 1 to 5% by mass, and further preferably from 2 to 4% by mass. When the content is less than 0.1% by mass, it may be difficult to provide an aqueous dispersion, and when the content exceeds 10% by mass, there may be a tendency of deteriorating the weather resistance.

There is a tendency that when the acid-modified polyolefin resin has a larger molecular weight, the mechanical properties and the weather resistance thereof may be better. Accordingly, the melt flow rate (MFR) at 190° C. and a load 2,160 g (according to JIS K7210:1999), which is an index of the molecular weight, is preferably 500 g/10 minutes or less, more preferably 300 g/10 minutes or less, and further preferably 100 g/10 minutes or less, and is preferably 0.001 g/10 minutes or more, more preferably 0.01 g/10 minutes or more, further preferably 0.05 g/10 minutes or more, and particularly preferably 0.1 g/10 minutes or more. When the melt flow rate exceeds 300 g/10 minutes, there may be a tendency of deteriorating the weather resistance and the acid rain resistance, and when it is less than 0.001 g/10 minutes, there may be a restriction in production of a resin having a large molecular weight.

There is a tendency that when the acid-modified polyolefin resin has a higher melting point, the weather resistance thereof may be better. Accordingly, the melting point thereof is preferably 70° C. or more, more preferably from 75 to 200° C., and further preferably from 80 to 170° C. When the melting point is less than 70° C., there may be a tendency that the adhesion force at a high temperature is lowered, and when the melting point exceeds 200° C., there may be a tendency that it is difficult to form an aqueous dispersion.

In the invention, the acid-modified polyolefin resin preferably contains an unsaturated carboxylate ester or a (meth)acrylate ester component, for providing sufficient adhesion property to a filler.

Preferred examples of the unsaturated carboxylate ester component include ester components of acrylic acid, methacrylic acid, maleic acid, maleic anhydride, itaconic acid, itaconic anhydride, fumaric acid, and crotonic acid. Among these, ester components of acrylic acid and methacrylic acid are preferred.

Examples of the (meth)acrylate ester component include an ester compound of (meth)acrylic acid and an alcohol having from 1 to 30 carbon atoms, and among these, an ester compound of (meth)acrylic acid and an alcohol having from 1 to 20 carbon atoms, from the standpoint of the availability.

Specific examples of the (meth)acrylate ester component include methyl (meth)acrylate, ethyl (meth)acrylate, propyl (meth)acrylate, butyl (meth)acrylate, hexyl (meth)acrylate, octyl (meth)acrylate, decyl (meth)acrylate, lauryl (meth)acrylate, dodecyl (meth)acrylate, and stearyl (meth) acrylate, and mixtures thereof may be used. Among these, methyl (meth)acrylate, ethyl (meth)acrylate, butyl (meth)acrylate, hexyl acrylate, and octyl acrylate are preferred, ethyl acylate and butyl acylate are more preferred, and ethyl acrylate is particularly preferred, from the standpoint of the availability and the adhesion property. The expression “(meth)acrylic acid” and the like herein mean “acrylic or methacrylic acid” and the like.

The content of the unsaturated carboxylate ester or (meth) acrylate ester component in the acid-modified polyolefin resin is preferably from 0.1 to 25% by mass, more preferably from 1 to 20% by mass, further preferably from 2 to 18% by mass, and particularly preferably from 3 to 15% by mass. When the content of the unsaturated carboxylate ester or (meth)acrylate ester component is less than 0.1% by mass, there may be a tendency that the adhesion property is deteriorated, and when the content exceeds 25% by mass, there may be a tendency that the weather resistance and the acid resistance are deteriorated.

The unsaturated carboxylate ester or (meth)acrylate ester component may be copolymerized in the acid-modified polyolefin resin with no limitation in the form thereof, and examples of the mode of copolymerization include random copolymerization, block copolymerization, and graft copolymerization (graft modification). Among these, the acid-modified polyolefin resin is preferably a terpolymer of ethylene, an unsaturated carboxylate ester, and an unsaturated carboxylic acid; or a terpolymer of an ethylene, an unsaturated carboxylate ester, and an anhydride of an unsaturated carboxylic acid; and in particular, the acid-modified polyolefin resin is preferably a terpolymer of an ethylene, an acrylate ester, and acrylic acid; a terpolymer of an ethylene, an acrylate ester, and an acrylic anhydride; a terpolymer of ethylene, a methacrylate ester, and acrylic acid; or a terpolymer of ethylene, a methacrylate ester, and an acrylic anhydride.

Specific examples of the acid-modified polyolefin resin include an ethylene-(meth)acrylate ester-maleic anhydride copolymer, an ethylene-propylene-(meth)acrylate ester-maleic anhydride copolymer, an ethylene-butene-(meth)acrylate ester-maleic anhydride copolymer, a propylene-butene-(meth)acrylate ester-maleic anhydride copolymer, an ethylene-propylene-butene-(meth)acrylate ester-maleic anhydride copolymer, an ethylene-acrylic acid copolymer, an ethylene-methacrylic acid copolymer, an ethylene-maleic anhydride copolymer, an ethylene-propylene-maleic anhydride copolymer, an ethylene-butene-maleic anhydride copolymer, a propylene-butene-maleic anhydride copolymer, and an ethylene-propylene-butene-maleic anhydride copolymer, and among these, an ethylene-(meth)acrylate ester-maleic anhydride copolymer is the most preferred. The mode of the copolymers may be any of a random copolymer, a block copolymer, and a graft copolymer, and a random copolymer and a graft copolymer are preferred from the standpoint of the availability.

In the invention, the acid-modified polyolefin resin is preferably formed into an aqueous dispersion, for enhancing the weather resistance and the acid resistance, and for facilitating to make the adhesive layer thin. The aqueous dispersion is also preferred for facilitating mixing with a crosslinking agent and the like.

In view of such factors as the various capabilities and the easiness of making the thickness uniform on coating, the acid-modified polyolefin resin in the aqueous dispersion preferably has a number average particle diameter of 1 μm or less, more preferably 0.5 μm or less, further preferably 0.2 μm or less, and particularly preferably 0.1 μm or less. A polyolefin structure that is incompatible with a polyester and is capable of being microdispersed may be selected among the polyolefin resins, for further enhancing the recyclability.

### Basic Compound

The coating layer further contains a basic compound having a boiling point of 200° C. or less. The basic compound has a function of improving the dispersibility of the acid-modified polyolefin resin in an aqueous coating solution. The acid-modified polyolefin resin is water insoluble, and thus the basic compound is used for dispersing the acid-modified polyolefin resin in an aqueous coating solution. Thus, the basic compound makes the acid-modified polyolefin resin in the form of an aqueous dispersion.

The basic compound neutralizes the carboxyl groups in the acid-modified polyolefin resin in the aqueous coating solution. The fine particles may be prevented from being agglomerated by the electric repulsion force among the carboxyl anions formed through the neutralization, and thereby the aqueous dispersion is stabilized to improve the dispersibility. The basic compound used in the invention may be one that is capable of neutralizing a carboxyl group. The basic compound that is added in this purpose functions as a hydrophilizing assistant.

In the aqueous dispersion, the carboxyl groups in the acid-modified polyolefin resin are preferably neutralized with the basic compound. The fine particles may be prevented from being agglomerated by the electric repulsion force among the carboxyl anions formed through the neutralization, and thereby the aqueous dispersion is stabilized. The basic compound used in the invention may be one that is capable of neutralizing a carboxyl group, and in the invention, particularly, a volatile basic compound having a boiling point of 200° C. or less is preferably used for enhancing the recyclability of a coated polyester film.

The amount of the basic compound having a boiling point of 200° C. or less that is added to the aqueous coating solution is preferably from 0.5 to 3.0 times by molar equivalent, more preferably from 0.8 to 2.5 times by molar equivalent, and further preferably from 1.01 to 2.0 times by molar equivalent, based on the molar number of the carboxyl groups in the acid-modified polyolefin resin.

The content of the basic compound having a boiling point of 200° C. or less that is contained in the coating layer is preferably from 0.1 to 2.5 times by molar equivalent, more preferably from 0.3 to 2.0 times by molar equivalent, and further preferably from 0.3 to 1.5 times by molar equivalent, based on the molar number of the carboxyl groups in the acid-modified polyolefin resin.

When the amount of the basic compound added is the aforementioned lower limit or more, the effect of addition of the basic compound may be effectively exhibited to provide a favorable aqueous dispersion. When the amount of the basic compound added is the aforementioned upper limit or less, the time required for the recycling step may be reduced. When the amount is less than 0.5 times by molar equivalent, the effect of addition of the basic compound may not be exhibited, and when the amount exceeds 3.0 times by molar equivalent, the recyclability may be deteriorated.

The basic compound used may be volatile one having a boiling point of 200° C. or less. The boiling point of the basic compound may be 200° C. or less, preferably 180° C. or less, and more preferably 160° C. or less. The boiling point of the basic compound is preferably −40° C. or more, and more preferably 0° C. or more. When the boiling point is the upper limit or less, the basic compound may be evaporated on heating the film, which has been recovered in the recycling step, in the drying step. When the boiling point is the lower limit or more, the proportion of the basic compound that is evaporated from the aqueous coating solution in the kneading step and the like may be reduced.

A basic compound accelerates alkaline hydrolysis of a polyester. Accordingly, when a basic compound is mixed in the raw material of the polyester film after recycling, there may be a problem that hydrolysis of the polyester is accelerated to decrease considerably the molecular weight of the polyester. Thus, the recycling efficiency may be largely deteriorated, or the recycling may not be performed.

In the invention, however, the basic compound has a boiling point of 200° C. or less to have volatility, and thereby the amount of the basic compound contained in the raw material of the polyester film may be decreased on recovering and recycling a part of the laminated film. In the invention, accordingly, the hydrolysis of the polyester may be suppressed to enhance largely the recycling efficiency, and thus the production cost of the laminated film may be suppressed.

The step of evaporating the basic compound is a step of removing the basic compound by drying and heating the recovered film.

The drying temperature is preferably from 100 to 200° C., more preferably from 120 to 180° C., and further preferably from 150 to 180° C. When the temperature is in the range, the basic compound may be evaporated while suppressing the decomposition reaction of the polyester.

The drying time is preferably from 1 to 24 hours, more preferably from 2 to 18 hours, and further preferably from 4 to 12 hours. When the period of time is in the range, the basic compound may be sufficiently removed while securing the productivity.

The basic compound having a boiling point of 200° C. or less is preferably ammonia or an organic amine compound. Specific examples of the organic amine compound include triethylamine, N,N-dimethylethanolamine, aminoethanolamine, N-methyl-N,N-diethanolamine, isopropylamine, iminobispropylamine, ethylamine, diethylamine, 3-ethoxypropylamine, 3-diethylaminopropylamine, sec-butylamine, propylamine, methylaminopropylamine, 3-methoxypropylamine, monoethanolamine, morpholine, N-methylmorpholine, and N-ethylmorpholine.

In the aqueous dispersion, an organic solvent is preferably added on hydrophilizing, for accelerating the hydrophilization of the acid-modified polyolefin resin for decreasing the dispersed particle diameter. The amount of the organic solvent used is preferably 40% by mass or less, more preferably from 1 to 40% by mass, more preferably from 2 to 35% by mass, and particularly preferably from 3 to 30% by mass, based on the mass of the aqueous coating solution. When the amount of the organic solvent exceeds 40% by mass, the aqueous coating solution is not deemed to be an aqueous medium substantially, which not only deviates from the environmental protection, but also deteriorates the stability of the aqueous dispersion in some cases depending on the organic solvent used. The organic solvent that is added on hydrophilizing may be appropriately reduced by distilling off to the outside of the system through a solvent removal process referred to as stripping, and the reduction of the amount of the organic solvent may not particularly influence the performance.

The organic solvent used in the invention preferably has a boiling point of from 30 to 250° C., and particularly preferably from 50 to 200° C. The organic solvent may be used as a mixture of two or more kinds thereof. When the boiling point of the organic solvent is less than 30° C., there are cases where the proportion thereof that is evaporated on hydrophilizing the resin may be large, and the efficiency of hydrophilization may not be sufficiently increased. An organic solvent having a boiling point exceeding 250° C. is difficult to be evaporated from the resin coated film by drying, and the water resistance of the coated film may be deteriorated in some cases.

As the organic solvent, ethanol, n-propanol, isopropanol, n-butanol, methyl ethyl ketone, cyclohexanone, tetrahydrofuran, dioxane, ethylene glycol monoethyl ether, ethylene glycol monopropyl ether, and ethylene glycol monobutyl ether are preferred from the standpoint of the high efficiency on accelerating hydrophilization of the resin and the easiness of removal of the organic solvent from the aqueous medium, and ethanol, n-propanol, and isopropanol are particularly preferred from the standpoint of the low temperature drying property.

The method for providing the aqueous dispersion in the invention is not particularly limited. For example, the method described in JP-A-2003-119328 may be employed, in which the components described above, i.e., the acid-modified polyolefin resin, the basic compound, water, and the organic solvent depending on necessity, are heated and agitated preferably in a sealable vessel, and this method is the most preferred. According to the method, the acid-modified polyolefin resin may be favorably formed into an aqueous dispersion with substantially no non-volatile hydrophilizing assistant added.

The solid concentration of the resin in the aqueous dispersion is not particularly limited, and is preferably from 1 to 60% by mass, more preferably from 2 to 50% by mass, and further preferably from 5 to 30% by mass, based on the total mass of the aqueous dispersion, from the standpoint of the easiness of coating and the easiness of controlling the thickness of the adhesive layer.

In the invention, for increasing the productivity in the in-line coating method, i.e., the film forming speed, the aqueous dispersion preferably contains a non-volatile hydrophilizing assistant, such as a surfactant and an emulsifier. In the ordinary techniques, the acid-modified polyolefin resin does not contain the non-volatile hydrophilizing assistant from the standpoint of the adhesion property and the weather resistance, but in the invention, the productivity and the various performances may be simultaneously achieved, more effectively, by selecting the appropriate non-volatile hydrophilizing assistant.

The non-volatile hydrophilizing assistant referred herein means a non-volatile compound that contributes to dispersion and stabilization of the resin. Examples of the non-volatile hydrophilizing assistant include a cationic surfactant, an anionic surfactant, a nonionic surfactant, an amphoteric surfactant, a fluorine surfactant, a reactive surfactant, and a water soluble polymer, and also include those generally used for emulsion polymerization, and an emulsifier, and a fluorine surfactant and a nonionic surfactant are particularly preferred.

These surfactants are nonionic and do not function as a catalyst for decomposition of the polyester, and thus they are excellent in recycling property. The amount of the surfactant added is preferably from 1 to 100 ppm, more preferably from 5 to 70 ppm, and particularly preferably from 10 to 50 ppm, based on the aqueous coating solution.

### Polyester Film

The polyester film of the invention contains a polyester. The kind of the polyester is not particularly limited, and known polyesters may be used.

The polyester is preferably a saturated polyester. The use of a saturated polyester may provide a polyester film that is excellent in mechanical strength, as compared to a film using an unsaturated polyester.

A polyester has a —COO— bond or an —OCO— bond within the polymer. The end group of the polyester is an —OH group, a —COOH group, or groups obtained by protecting these groups (i.e., an —OR^{x} group or a —COOR^{x} group (wherein R^{x} represents an arbitrary substituent, such as an alkyl group), and the polyester is preferably a linear saturated polyester synthesized from an aromatic dibasic acid or an ester-forming derivative thereof and a diol or an ester-forming derivative thereof. Examples of the linear saturated polyester include those described in JP-A-2009-155479 and JP-A-2010-235824, which may be appropriately used.

Specific examples of the linear saturated polyester include polyethylene terephthalate (PET), polyethylene isophthalate, polybutylene terephthalate, poly(1,4-cyclohexylenedimethylene terephthalate), and polyethylene-2,6-naphthalate, and among these, polyethylene terephthalate and polyethylene-2,6-naphthalate are particularly preferred, and polyethylene terephthalate is further particularly preferred, from the standpoint of the mechanical property and the cost.

The polyester may be a homopolymer or a copolymer. The polyester may contain a small amount of a resin other than a polyester, such as a polyimide, mixed therein. The polyester used may be a crystalline polyester capable of forming anisotropy on melting.

The molecular weight of the polyester is preferably from 5,000 to 30,000, more preferably from 8,000 to 26,000, and particularly preferably from 12,000 to 24,000, in terms of weight average molecular weight (Mw), from the standpoint of the heat resistance and the viscosity. The weight average molecular weight of the polyester may be a polymethyl methacrylate (PMMA) conversion value measured by gel permeation chromatography (GPC) using hexafluoroisopropanol as a solvent.

The thickness of the polyester film is preferably from 30 to 400 μm, and more preferably from 50 to 250 μm. The polyester film in the invention may be formed of one layer of a polyester film or a laminate of two or more layers of polyester films (for example, a co-cast film and a co-extruded film). In the case where the polyester film in the invention is formed of two or more layers, the total thickness thereof is preferably in the aforementioned range.

The polyester film may be subjected to a surface treatment. Examples of the surface treatment in this case include a corona treatment, a flame treatment, a vacuum plasma treatment, an atmospheric pressure plasma treatment, and a glow discharge treatment. The surface treatment on the surface of the polyester film may further enhance the adhesion property to the coating layer.

The polyester film preferably has a refractive index of from 1.63 to 1.71, and more preferably from 1.62 to 1.68, from the standpoint of the transparency.

The polyester film may further contain other additives in such a range that does not deviate from the substance of the invention, and examples of the additives include an antioxidant and an ultraviolet ray shielding agent.

The polyester may be synthesized by a known method. For example, the polyester may be synthesized by a known polycondensation method or a known ring-opening polymerization method, and any of ester exchange reaction and reaction by direct polymerization may be used.

In the case where the polyester used in the invention is a polymer or a copolymer that is obtained by condensation reaction of an aromatic dibasic acid or an ester-forming derivative thereof and a diol or an ester-forming derivative thereof, as major components, the polyester may be produced by subjecting the aromatic dibasic acid or an ester-forming derivative thereof and the diol or an ester-forming derivative thereof to esterification reaction or ester exchange reaction, and then subjecting them to polycondensation reaction. The carboxyl acid value and the intrinsic viscosity of the polyester may be controlled by selecting the raw materials and the reaction conditions. A polymerization catalyst is preferably added in the esterification reaction or ester exchange reaction and the polycondensation reaction, for effectively performing these kinds of reaction.

The polymerization catalyst used in the polymerization of the polyester is preferably a Sb compound, a Ge compound and a Ti compound, and a Ti compound is particularly preferred from the standpoint of controlling the content of the carboxyl group to a prescribed range. In the case where a Ti compound is used, such an embodiment is preferred that the polymerization is performed by using a Ti compound as a catalyst in an amount of from 1 to 30 ppm, and more preferably from 3 to 15 ppm. When the proportion of the Ti compound is in the range, the end carboxyl group may be controlled to the range described later, and thus the hydrolysis resistance of the polymer base film may be maintained high.

The polyester after the polymerization is preferably subjected to solid phase polymerization. According to the procedure, a preferred carboxylic acid value may be achieved. The solid phase polymerization may be performed by a continuous method (in which the resin filled in a tower is slowly circulated under heating for a prescribed period of time, and then delivered) or a batch method (in which the resin placed in a vessel is heated for a prescribed period of time). Specifically, the solid phase polymerization applied herein may be the methods described in Japanese Patent Nos. 2,621,563, 3,121,876, 3,136,774, 3,603,585, 3,616,522, 3,617,340, 3,680,523, 3,717,392, and 4,167,159, and the like.

The temperature in the solid phase polymerization is preferably from 170 to 240° C., more preferably from 180 to 230° C., and further preferably from 190 to 220° C. The solid phase polymerization time is preferably from 5 to 100 hours, more preferably from 10 to 75 hours, and further preferably from 15 to 50 hours. The solid phase polymerization is preferably performed in vacuum or in a nitrogen atmosphere.

Compound Derived from Acid-Modified Polyolefin Resin

The polyester film contains a compound that is derived from the acid-modified polyolefin resin contained in the coating layer. In the invention, the compound that is derived from the acid-modified polyolefin resin means a substance in which a part of the acid-modified polyolefin resin contained in the coating layer is mixed in a small amount into the polyester film on recycling.

In the invention, scrap films that do not become a product in the production of the laminated film, and the laminated films that do not satisfy the product standard may be recycled as a recycled film, which may be reused as a film raw material. Examples of the scrap films include the edge part of the film that is grasped on stretching in the stretching step, and the edge part thereof that is not coated with the coating solution, and the like.

The recycled film is heated in the drying step and then used for the production of a new polyester film. The dried recycled film is melted by heating and then separated in the subsequent step into a polyester resin and an acid-modified polyolefin resin. In this case, the polyester resin contains a small amount of the compound that is derived from the acid-modified polyolefin resin contained in the coating layer of the recycled film.

In the invention, the basic compound contained in the recycled film may be evaporated in the drying step since the volatile basic compound is used. Accordingly, the polyester contained in the film raw material and the like after recycling may be reused without decreasing the molecular weight thereof.

The content of the compound that is derived from the acid-modified polyolefin resin is preferably from 10 to 1,000 ppm based on the mass of the polyester film. The content of the compound that is derived from the acid-modified polyolefin resin is preferably 10 ppm or more, more preferably 30 ppm or more, and further preferably 50 ppm or more. The content thereof is preferably 1,000 ppm or less, more preferably 900 ppm or less, and further preferably 800 ppm or less.

In the invention, the polyester film contains the compound that is derived from the acid-modified polyolefin resin, and thereby the polyester film may be prevented from being deteriorated. The polyester film containing the compound that is derived from the acid-modified polyolefin resin has a high IV value and a low AV value, as compared to the polyester film that does not contain the compound that is derived from the acid-modified polyolefin resin. Accordingly, the polyester film containing the compound that is derived from the acid-modified polyolefin resin suffers less thermal deterioration and becomes a film with good quality. While not sticking to any theory, it is considered that this is because by using the polyester film containing the compound that is derived from the acid-modified polyolefin resin, the plasticized state in the extruder is changed, and the molten temperature inside the extruder is decreased.

### Production Method

The invention also relates to a method for producing a laminated film containing a polyester film and a coating layer. The method for producing a laminated film contains coating a coating solution on at least one surface of a polyester film, and stretching the resultant to form a coating layer. The coating solution contains a basic compound having a boiling point of 200° C. or less and an acid-modified polyolefin resin, and, the polyester film contains a compound that is derived from the acid-modified polyolefin resin contained in the coating layer.

The polyester film used in the invention may be produced in the following manner. In the production of the polyester film, a resin mixture containing a polyester resin and an acid-modified polyolefin resin is dried in a drying step. The drying step is a step of drying the resin mixture by heating, and the drying temperature is preferably from 100 to 200° C., more preferably from 120 to 180° C., and further preferably from 150 to 180° C. In the case where the resin mixture contains a basic compound in the drying step, the basic compound may be evaporated.

In the invention, the resin mixture may contain a recycled film. In the case where the resin mixture contains a recycled film, a cutting step is preferably provided before the drying step. The cutting step is a step of cutting a recycled film, such as an edge part of the film and a defective film, into a certain size or smaller. The recycled film is cut into a certain size or smaller, and thereby the period of time taken for the subsequent step described later may be reduced.

In the case where the resin mixture contains the recycled film, the recycled film is preferably contained in an amount of from 20 to 80% by mass, more preferably from 25 to 75% by mass, and further preferably from 30 to 70% by mass, based on the polyester resin.

Thereafter, the resin mixture is placed in a kneading device and kneaded. Various kneading devices may be used for kneading, such as a single screw extruder, a twin screw extruder, a Banbury mixer, and a Brabender mixer. Among these, a twin screw extruder is preferably used since a part of the basic compound may be evaporated. The kneading temperature is preferably from the crystal melting temperature (Tm) of the polyester resin to Tm+80° C., more preferably from Tm+10° C. to Tm+70° C., and further preferably from Tm+20° C. to Tm+60° C. The kneading atmosphere may be any of the air, vacuum, and an inert gas stream, and vacuum and an inert gas stream are preferred since the basic compound may be evaporated more efficiently therein.

The resin mixture thus kneaded is placed in a single screw or twin screw extruder, and melted under heat therein. The temperature for melting under heat in this case is preferably from the crystal melting temperature (Tm) of the polyester resin to Tm+80° C., more preferably from Tm+5° C. to Tm+60° C., and further preferably from Tm+10° C. to Tm+50° C. The melting time is preferably from 1 to 30 minutes, more preferably from 1 to 20 minutes, and further preferably from 3 to 15 minutes. Thereafter, the molten resin mixture is discharged from a die into a soft sheet form.

After the heating and melting step, a separating step of separating the heat-molten resin mixture into the polyester resin and the acid-modified polyolefin resin may be provided. The polyester resin thus obtained in the separating step contains a small amount of the compound that is derived from the acid-modified polyolefin resin contained in the coating layer of the laminated film having been produced as the previous lot.

The acid-modified polyolefin resin thus separated in the separating step may also be reused as the film material for the next lot.

The resin mixture sheet (polyester sheet) thus discharged from the die is preferably passed through a gear pump and a filter through a melt pipe. It is also preferred to provide a static mixer in the course of the melt pipe for facilitating mixing of the resin with additives and the like.

The polyester sheet is extruded onto a casting roll and solidified by cooling to be a film. The film thus obtained is a polyester sheet in the form of a cast film (unstretched original film).

The temperature of the casting roll is preferably from 0 to 60° C., more preferably from 5 to 55° C., and further preferably from 10 to 50° C. In this case, for enhancing the flatness by enhancing adhesion between the melt and the cooling drum, an electrostatic adhesion method, an air knife method, application of water to the cooling drum, and the like may also be preferably employed. For performing the cooling more efficiently, furthermore, cold air may be blown onto the cooling drum.

The polyester sheet is delivered to a longitudinal stretching device, and stretched in the longitudinal direction. Thereafter, both edges of the polyester sheet are grasped with clips disposed horizontally in a transverse stretching device, and the polyester sheet is stretched in the transverse direction while being delivered to a winding device, so as to be the polyester film.

The coating layer is formed by coating on the surface of the polyester film before the stretching step or between steps within the stretching step. In the case where the coating step is provided between steps within the stretching step, at least one stretching step is provided after the coating step.

For example, in the case where the coating step is provided before stretching in the longitudinal direction and the transverse direction, the steps may be performed sequentially in the order of: coating, longitudinal stretching and transverse stretching; or coating, transverse stretching and longitudinal stretching, or may be performed in such a manner that simultaneous stretching in the two directions is performed after the coating step. The stretching steps are also preferably performed by dividing into plural stages, and for example, the steps may be performed in the order of: coating, longitudinal stretching, longitudinal (transverse) stretching and transverse stretching; longitudinal stretching, coating, longitudinal (transverse) stretching and transverse stretching; or longitudinal stretching, longitudinal (transverse) stretching, coating and transverse stretching.

On coating the coating layer, an aqueous solution or an aqueous dispersion (latex) is preferably coated. The acid-modified polyolefin is water insoluble, and therefore the basic compound having a boiling point of 200° C. or less is added to the aqueous solution or the aqueous dispersion (latex) as a neutralizing agent for imparting dispersion stability thereto. The coating method is not particularly limited, and a known coating method, such as a coating method with a bar coater or a slide coater, may be employed.

After coating the coating solution on the polyester film, the coated solution is cured by drying to form the coating layer. In the case where the coating layer has a two-layer structure, it is preferred to perform drying after coating the second layer.

The longitudinal stretching is preferably performed at from Tg−10° C. to Tg+50° C., more preferably from Tg to Tg+40° C., and further preferably from Tg+10° C. to Tg+35° C. The stretching ratio is preferably from 2 to 5 times, more preferably from 2.5 to 4.5 times, and further preferably from 3 to 4 times.

After the longitudinal stretching, the film is preferably cooled, and the temperature thereof is preferably from Tg−50° C. to Tg, more preferably from Tg−45° C. to Tg−5° C., and further preferably from Tg−40° C. to Tg−10° C. The cooling may be performed by making the film into contact with a cooling roll or may be blown with cold air.

In the case where the transverse stretching is performed thereafter, the transverse stretching is preferably performed with a tenter. The transverse stretching may be performed in such a manner that while grasping the both edges of the polyester film with clips, the film is conveyed in the heat treatment zone and stretched in the transverse direction by expanding the clips in the width direction.

The stretching temperature is preferably from Tg to Tg+100° C., more preferably from Tg+10° C. to Tg+80° C., and further preferably from Tg+20° C. to Tg+70° C. The stretching ratio is preferably from 2 to 5.5 times, more preferably from 2.5 to 5 times, and further preferably from 3 to 4.5 times.

A preheating step for the polyester sheet may be provided before the stretching step. The preheating temperature is preferably from Tg of the polyester−50° C. to Tg+30° C., more preferably from Tg−40° C. to Tg+15° C., and further preferably from Tg−30° C. to Tg. The preheating may be performed by making in contact with a heating roll, by using a radiant heat source (such as an IR heater and a halogen lamp heater), or by blowing hot air.

In the invention, the sequence of steps including coating the coating solution on at least one surface of the polyester film, and then stretching is referred to as a film forming step. The coating solution contains the basic compound having a boiling point of 200° C. or less and the acid-modified polyolefin resin.

After the stretching step, the film having been stretched is preferably subjected to heat fixing and relaxing. The heat fixing is a procedure for subjecting the film to a heat treatment at approximately from 180 to 210° C. (more preferably from 185 to 210° C.) for from 1 to 60 seconds (more preferably from 2 to 30 seconds). In the heat fixing and relaxing steps provided after the stretching step, a part of the volatile basic compound having a boiling point of 200° C. or less may be evaporated.

The heat fixing is preferably performed in the state where the film is grasped with chucks within the tenter subsequent to the transverse stretching, and at this time, the distance between the chucks may be maintained to the width after completing the transverse stretching, may be further expanded, or may be narrowed. The heat fixing performed may form microcrystals and may enhance the mechanical characteristics and the durability.

Subsequent to the heat fixing, a relaxing treatment is preferably performed. The heat relaxing treatment is a treatment of contracting the film for stress relaxation by heating. In the heat relaxing treatment, the relaxation is preferably performed in at least one of the longitudinal and transverse directions, and the relaxation amount is preferably from 1 to 15%, more preferably from 2 to 10%, and further preferably from 3 to 8%, in terms of the ratio with respect to the width after the transverse stretching, in both the longitudinal and transverse directions. The relaxation temperature is preferably from Tg+50° C. to Tg+180° C., more preferably from Tg+60° C. to Tg+150° C., and further preferably from Tg+70° C. to Tg+140° C.

The heat relaxation is preferably performed at from the melting point Tm of the polyester−100° C. to Tm−10° C., more preferably Tm−80° C. to Tm−20° C., and further preferably from Tm−70° C. to Tm−35° C. According to the procedure, the formation of crystals may be facilitated, and the mechanical strength and the heat shrinkability may be improved. The heat fixing at Tm−35° C. or less may enhance the hydrolysis resistance. This is because the reactivity with water is suppressed by increasing the tension (containment) of the amorphous portion, which is liable to be hydrolyzed, without breakage of the orientation therein.

The transverse relaxation may be performed by narrowing the width distance of the clips of the tenter. The longitudinal relaxation may be performed by narrowing the distance of the adjacent clips of the tenter. This may be achieved in such a manner that the adjacent clips are connected in a pantograph form, and the pantograph is closed. Furthermore, after taking out the film from the tenter, the film may be conveyed and heat-treated under a low tension to perform relaxation. The tension of the film is preferably from 0 to 0.8 N/mm², more preferably from 0 to 0.6 N/mm², and further preferably from 0 to 0.4 N/mm², with respect to the cross sectional area of the film. The tension of 0 N/mm² may be achieved in such a manner that two or more pairs of nip rolls are provided on conveying, and the film is slack (suspended) between them.

The film going out from the tenter is trimmed to cut both edges thereof grasped by the clips, and the both edges are knurled (embossed), followed by winding the film. The width thereof is preferably from 0.8 to 10 m, more preferably from 1 to 6 m, and further preferably from 1.5 to 4 m. The thickness thereof is preferably from 30 to 300 μm, more preferably from 40 to 280 μm, and further preferably from 45 to 260 μm. The thickness may be controlled by adjusting the ejection amount of the extruder, and the film forming speed (i.e., the speed of the cooling roll, and the stretching speed coordinating therewith, and the like).

The recycled films, such as the trimmed edges of the film, are recovered as a resin mixture and recycled. The recycled film is used as a film raw material for the laminated film of the next lot and returned to the drying step, and the production processes are then repeated sequentially.

### EXAMPLES

The features of the invention will be described in more detail with reference to examples and comparative examples below. The materials, the amounts thereof used, proportions, the contents of procedures, the process steps of procedures, and the like shown in the examples below may be appropriately changed unless they deviate from the substance of the invention. Therefore, the scope of the invention is not construed as being limited to the specific examples shown below.

### Example 1

### Polymerization of Polyester Resin

A polyester resin was polymerized according to Example 1 of JP-A-2011-208125, and used as raw material pellets for the laminated polyester film.

### Preparation of Aqueous Coating Solution for Forming Coating Layer

In a sealable pressure resistant glass vessel having a capacity of 1 L equipped with an agitator and a heater, 50.0 g (10% by mass) of Nucrel N1214 (produced by Du Pont-Mitsui Polychemicals Co., Ltd.), a copolymer resin of ethylene and methacrylic acid, 175.0 g (35% by mass) of n-propanol as the organic solvent, 12.7 g of 28% aqueous ammonia (3 times by molar equivalent based on the molar number of COCH) as the basic compound, and 262.3 g of distilled water were charged as raw materials, and after sealing the vessel, the raw materials were agitated by rotating the agitation blades at a rotation speed of 400 rpm. As a result, precipitation of resin particles was not found on the bottom of the vessel, but the resin was in a suspended state. The glass vessel was then entirely covered with a heat retaining material, and the heater was turned on to make the temperature of the system to 170° C., followed by further agitating for 60 minutes. Thereafter, the heater was turned off, and the system was spontaneously cooled to 80° C. while agitating the system at a rotation speed of 400 rpm maintained. At this time, the period of time required for decreasing the temperature of the system from 120° C. to 80° C. was 1 hour. Thereafter, the heat retaining material was detached from the glass vessel, and the lower half of the glass vessel was immersed in water for cooling with water. The agitation was stopped at the time when the temperature of the system reached 35° C., and the content of the glass vessel was filtered with a 460-mesh stainless steel filter to provide an aqueous dispersion having a solid content of 25%. The characteristics of the aqueous dispersion are shown in Table 1.

Subsequently, a coating solution having the following composition was prepared by using the aqueous dispersion.

| Acid-modified polyolefin aqueous | 24 | parts by mass |
|---|---|---|
| dispersion prepared above | | |
| Nonionic surfactant | 0.2 | part by mass |
| (Naroacty CL-95, produced by | | |
| Sanyo Chemical Industries, Ltd., | | |
| concentration: 1% by mass) | | |
| Oxazoline crosslinking agent | 4.0 | parts by mass |
| (Epocros WS-700, produced by | | |
| Nippon Shokubai Co., Ltd., | | |
| concentration: 25% by mass) | | |
| Distilled water | 72.0 | parts by mass |

### Formation of Laminated Film

A laminated film was produced by coating an aqueous coating solution containing a basic compound having a boiling point of 200° C. or less and an acid-modified polyolefin resin on at least one surface of a polyester film, and stretching, thereby forming a coating film.

### Extrusion Molding

The pellets of the polyester resin were dried to a water content of 20 ppm or less, placed in a hopper of a twin screw kneading extruder having a diameter of 50 mm, melted at 270° C., and extruded. The molten material (melt) was passed through a gear pump and a filter (pore diameter: 20 μm) and then extruded from a die onto a cooling roll at 20° C. to provide an amorphous sheet. The melt thus extruded was attached to the cooling roll by an electrostatic adhesion method.

### Stretching and Coating

The unstretched film having been extruded onto the cooling roll and solidified in the aforementioned method was sequentially subjected to biaxial stretching in the following manner to provide a polyester film having a thickness of 250 μm.

### Stretching Method

### (a) Longitudinal Stretching

The unstretched film was passed through two pairs of nip rolls having different circumferential velocities and thus stretched in the longitudinal direction (machine direction). The stretching was performed at a preheating temperature of 75° C., a stretching temperature of 90° C., a stretching ratio of 3.4 times, and a stretching speed of 3,000% per second.

### (b) Coating

The coating solution above was coated on the base having been longitudinally stretched, to an amount of 0.6 g/m² with a bar coater.

### (c) Transverse Stretching

The film having been longitudinally stretched and coated was transversely stretched with a tenter under the following conditions.

### Conditions

Preheating temperature: 110° C.
Stretching temperature: 120° C.
Stretching ratio: 4.2 times
Stretching speed: 70% per second

### Heat Fixing and Heat Relaxation

Subsequently, the stretched film having been longitudinally stretched and transversely stretched was subjected to heat fixing under the following conditions. After the heat fixing, the film was subjected to heat relaxation by narrowing the distance of the tenter clips.

### Heat Fixing Conditions

Heat fixing temperature: 215° C.
Heat fixing time: 2 seconds

### Heat Relaxation Conditions

Heat relaxation temperature: 210° C.
Heat relaxation ratio: 2%

### Winding

After the heat fixing and the heat relaxation, the both edges of the film were trimmed by 10 cm each. Thereafter, the both edges of the film were embossed (knurled) for a width of 10 mm, and the film was wound at a tension of 25 kg/m. The film had a width of 1.5 m and a wound length of 2,000 m.

### Examples 2 to 16

Laminated films of Examples 2 to 6 were formed in the same manner as in Example 1 except that the kind of basic compound was changed. In Example 7, Bondine TX 8030 (a terpolymer of low density polyethylene, ethyl acrylate, and maleic anhydride, produced by Arkema Co., Ltd.) was used as the acid-modified polyolefin resin. In Example 8, Bondine X 4110 (a terpolymer of low density polyethylene, ethyl acrylate, and maleic anhydride, produced by Arkema Co., Ltd.) was used as the acid-modified polyolefin resin. In Example 9, AX 8390 (a terpolymer of low density polyethylene, ethyl acrylate, and maleic anhydride, produced by Arkema Co., Ltd.) was used as the acid-modified polyolefin resin. In Examples 10 to 12, the thickness of the coating layer was changed by controlling a solid content concentration of the coating solution. In Examples 13 and 14, the amount of the neutralizing agent was changed. In Examples 15 and 16, the kind of the polymerization catalyst of the polyester resin was changed.

In Comparative Example 1, a laminated film was formed by referring to Example 1 of JP-A-H07-17885. In Comparative Examples 2 and 3, basic compounds outside the scope of the invention were used. In Comparative Examples 4 and 5, laminated films were formed by an off-line coating method. The composition and evaluation result for performance of each laminated film are shown in Table 1.

### Evaluation Methods

Evaluation of Adhesion before Pressure Cooker Test (PCT)

The resulting laminated film was cut to a size of 22 mm in width×150 mm to provide two sheets of specimens. The two specimens were disposed to make the coated layers face each other, between which an EVA sheet (EVA sheet RC02B, produced by Mitsui Chemicals Fabro, Inc.) cut to a size of 20 mm in width×100 mm in length was inserted, and the assembly was hot-pressed with a vacuum laminator (vacuum laminator, produced by Nisshinbo Mechatronics, Inc.) to adhere the films to EVA. The adhesion conditions herein were as follows.

By using the vacuum laminator, the assembly was evacuated at 150° C. for 3 minutes, and then adhered by pressing for 10 minutes. Thus, a specimen for evaluating adhesion was produced, in which a portion of 50 mm from one edge of the two specimens adhered to each other was not adhered to EVA, and the remaining 100 mm portion was adhered to EVA sheet.

The portion of the obtained specimen for evaluating adhesion that was not adhered to EVA (i.e., the portion of 50 mm from the edge of the specimens) was grasped with clips vertically disposed in Tensilon (RTC-1210A, produced by Orientec Co., Ltd.), and the specimen was subjected to a tensile test at a peeling angle of 180° and a tensile speed of 300 mm/min for measuring the adhesion force. The specimen was evaluated based on the adhesion force thus measured according to the following evaluation standard. The levels A and B are practically allowable.

### Evaluation Standard

A: very good adhesion (10 N/mm or more)
B: good adhesion (3 N/mm or more and less than 10 N/mm)
C: slightly poor adhesion (less than 3 N/mm)
Evaluation of Adhesion after Pressure Cooker Test (PCT) for 60 Hours

The specimen for evaluating adhesion was subjected to a moisture resistance test at 120° C. and 100% for 60 hours, and the specimen for evaluating adhesion after the moisture resistance test was evaluated in the aforementioned method for peeling test.

### Change of Molecular Weight of Polyester

The films of Examples and Comparative Examples were pulverized into chips with a pulverizer and dried to a water content of 20 ppm or less, and the chips were placed in a hopper of a twin screw kneading extruder having a diameter of 20 mm, melted at 270° C., and extruded. The polyester was measured for intrinsic viscosity before and after the extrusion, and the difference thereof is shown in Table 1.

The intrinsic viscosity (IV) is defined in such a manner that 1 is subtracted from the ratio of the solution viscosity (η) and the solvent viscosity (η0) (i.e., the relative viscosity nr=η/η0) to provide the specific viscosity (ηsp=ηr−1), and the value obtained by dividing the specific viscosity rjsp by the concentration is extrapolated to a concentration of 0 to provide the intrinsic viscosity. The IV may be obtained from the solution viscosity at 25° C. in a mixed solvent of 1,1,2,2-tetrachloroethane and phenol (⅔ by mass).

### Productivity

A: The recycling rate of the laminated film in film formation is 40% or more.
B: The recycling rate of the laminated film in film formation is 20% or more.
C: The recycling rate of the laminated film in film formation is 20% or less.

TABLE 1

| | coating layer (coating solution) | | | | | | | |
|---|---|---|---|---|---|---|---|---|
| | | Constitution of | | | | | | |
| | | acid-modified polyolefin | | | | | | |
| | | resin (% by weight) | | | | | Ratio of basic | |
| | | | Unsaturated | | Basic compound | Boiling point | compound to | |
| | | Unsaturated | carboxylic | | (neutralizing | of basic | carboxyl | Coating |
| | Kind of binder | polyester | acid | MFR | agent) | compound | groups | method |
| | Unit | | | | | | | |
| | — | % by weight | | g/10 minutes | — | ° C. | — | — |
| Example 1 | acid-modified | 0 | 12 | 14 | ammonia | −33 | 1.0 | in-line |
| | polyolefin | | | | | | | |
| Example 2 | acid-modified | 0 | 12 | 14 | dimethylamine | 7 | 1.0 | in-line |
| | polyolefin | | | | | | | |
| Example 3 | acid-modified | 0 | 12 | 14 | isopropylamine | 33 | 1.0 | in-line |
| | polyolefin | | | | | | | |
| Example 4 | acid-modified | 0 | 12 | 14 | triethylamine | 90 | 1.0 | in-line |
| | polyolefin | | | | | | | |
| Example 5 | acid-modified | 0 | 12 | 14 | dimethylamino- | 130 | 1.0 | in-line |
| | polyolefin | | | | ethanol | | | |
| Example 6 | acid-modified | 0 | 12 | 14 | ethanolamine | 170 | 1.0 | in-line |
| | polyolefin | | | | | | | |
| Example 7 | acid-modified | 12 | 3 | 3 | triethylamine | 90 | 1.0 | in-line |
| | polyolefin | | | | | | | |
| Example 8 | acid-modified | 7 | 3 | 5 | triethylamine | 90 | 1.0 | in-line |
| | polyolefin | | | | | | | |
| Example 9 | acid-modified | 30 | 2 | 7 | triethylamine | 90 | 1.0 | in-line |
| | polyolefin | | | | | | | |
| Example 10 | acid-modified | 12 | 3 | 3 | triethylamine | 90 | 1.0 | in-line |
| | polyolefin | | | | | | | |
| Example 11 | acid-modified | 12 | 3 | 3 | triethylamine | 90 | 1.0 | in-line |
| | polyolefin | | | | | | | |
| Example 12 | acid-modified | 12 | 3 | 3 | triethylamine | 90 | 1.0 | in-line |
| | polyolefin | | | | | | | |
| Example 13 | acid-modified | 0 | 12 | 14 | triethylamine | 90 | 0.5 | in-line |
| | polyolefin | | | | | | | |
| Example 14 | acid-modified | 0 | 12 | 14 | triethylamine | 90 | 3.0 | in-line |
| | polyolefin | | | | | | | |
| Example 15 | acid-modified | 0 | 12 | 14 | triethylamine | 90 | 1.0 | in-line |
| | polyolefin | | | | | | | |
| Example 16 | acid-modified | 0 | 12 | 14 | triethylamine | 90 | 1.0 | in-line |
| | polyolefin | | | | | | | |
| Comparative | polyester | — | — | — | ammonia | −33 | 1.0 | in-line |
| Example 1 | | | | | | | | |
| Comparative | acid-modified | 0 | 12 | 14 | diethanolamine | 217 | 1.0 | in-line |
| Example 2 | polyolefin | | | | | | | |
| Comparative | acid-modified | 0 | 12 | 14 | KoH | 1,320 | 1.0 | in-line |
| Example 3 | polyolefin | | | | | | | |
| Comparative | acid-modified | 12 | 3 | 3 | ammonia | −33 | 1.0 | off-line |
| Example 4 | polyolefin | | | | | | | |
| Comparative | acid-modified | 0 | 12 | 14 | KOH | 1,320 | 1.0 | off-line |
| Example 5 | polyolefin | | | | | | | |

| | | | Support | | | | | | |
|---|---|---|---|---|---|---|---|---|---|
| | | | | Content of | | | | | |
| | Coating layer | | | compound | | | | | |
| | Ratio of | | | derived from | | Evaluation of performance | | | |
| | basic | | | acid-modified | | | | Change of | |
| | compound to | Thickness | | polyolefin | | | Adhesion | molecular | |
| | carboxyl | of coating | | resin in | Polymerization | Adhesion | after PCT | weight of | |
| | groups | layer | Resin | polyester | catalyst | before PCT | for 60 hours | polyester | Productivity |
| | Unit | | | | | | | | |
| | — | μm | | ppm | — | — | — | dL/g | — |
| Example 1 | 1.0 | 0.5 | PET | 500 | Ti | A | B | 0.02 | A |
| Example 2 | 1.0 | 0.5 | PET | 500 | Ti | A | B | 0.02 | A |
| Example 3 | 1.0 | 0.5 | PET | 500 | Ti | A | B | 0.03 | A |
| Example 4 | 1.0 | 0.5 | PET | 500 | Ti | A | B | 0.03 | A |
| Example 5 | 1.0 | 0.5 | PET | 500 | Ti | A | B | 0.03 | A |
| Example 6 | 1.0 | 0.5 | PET | 500 | Ti | A | B | 0.04 | B |
| Example 7 | 1.0 | 0.5 | PET | 500 | Ti | A | A | 0.01 | A |
| Example 8 | 1.0 | 0.5 | PET | 500 | Ti | A | A | 0.01 | A |
| Example 9 | 1.0 | 0.5 | PET | 500 | Ti | A | B | 0.00 | A |
| Example 10 | 1.0 | 0.01 | PET | 10 | Ti | B | B | 0.00 | A |
| Example 11 | 1.0 | 0.10 | PET | 100 | Ti | A | A | 0.00 | A |
| Example 12 | 1.0 | 1.00 | PET | 1,000 | Ti | A | B | 0.03 | A |
| Example 13 | 0.5 | 0.5 | PET | 500 | Ti | B | B | 0.02 | A |
| Example 14 | 3.0 | 0.5 | PET | 500 | Ti | A | B | 0.04 | B |
| Example 15 | 1.0 | 0.5 | PET | 500 | Ge | A | C | 0.04 | B |
| Example 16 | 1.0 | 0.5 | PET | 500 | Sb | A | C | 0.04 | B |
| Comparative | 1.0 | 0.5 | PET | 0 | Ti | A | C | 0.02 | C |
| Example 1 | | | | | | | | | |
| Comparative | 1.0 | 0.5 | PET | 500 | Ti | A | C | 0.06 | C |
| Example 2 | | | | | | | | | |
| Comparative | 1.0 | 0.5 | PET | 500 | Ti | A | C | 0.10 | C |
| Example 3 | | | | | | | | | |
| Comparative | 1.0 | 3.0 | PET | 0 | Ti | B | C | 0.01 | A |
| Example 4 | | | | | | | | | |
| Comparative | 1.0 | 3.0 | PET | 0 | Ti | C | C | 0.10 | A |
| Example 5 | | | | | | | | | |

The adhesion before PCT and the productivity were favorable in Examples 1 to 16. Furthermore, the change of the molecular weight of the polyester caused by the recycling was small, from which it is understood that the recycling efficiency was high.

The adhesion after PCT for 60 hours was also favorable in Examples 1 to 14. Accordingly, it is understood that good adhesion is maintained after the lapse of time by the presence of Ti compound in the polyester.

In particular, the adhesion before PCT and the productivity were more favorable in Example 7 to 9. Accordingly, it is understood that it is preferable that an acid-modified polyolefin resin contains an unsaturated ester and an unsaturated carboxylic acid.

On the other hand, an acid-modified polyolefin resin was not contained in the laminated film of Comparative Example 1, and the boiling point of the basic compound was over 200° C. in Comparative Examples 2 and 3. The adhesion after PCT for 60 hours and the productivity in these Comparative Examples were poor. Furthermore, the change of the molecular weight of the polyester caused by the recycling was large, from which it is understood that the recycling efficiency was low in Comparative Examples 2 and 3.

The coating layer was not formed by an in-line coating method in Comparative Examples 4 and 5. In this case, it is understood that the adhesion after PCT for 60 hours was poor.

The laminated film of Comparative Example 1 corresponds to the film disclosed in JP-A-H07-17885, and the laminated film of Comparative Example 5 corresponds to the film disclosed in JP-A-2000-72879.

### Examples 17 to 20, and Comparative Examples 6 to 8

In Examples 17 to 20, the laminated film produced in Example 11 was recycled into chips to provide recycled chips. In Comparative Example 6, chips containing no recycled material were prepared. In Comparative Example 7, uncoated chips not subjected to an in-line coating method were prepared. In Comparative Example 8, chips of the laminated film containing no acid-modified polyolefin resin of Comparative Example 1 were prepared. Properties of each chip are shown in Table 2.

TABLE 2

| | | | Content of | | | | |
|---|---|---|---|---|---|---|---|
| | | | compound | | | | |
| | | | derived from | | | | |
| | | | acid-modified | | | | |
| | | | polyolefin | Outlet | | | |
| | | Recovery | resin in | temperature | Thickness | IV of | AV of |
| | Chips used | ratio | polyester | of extruder | of film | film | film |
| | Unit | | | | | | |
| | — | % | ppm | ° C. | μm | dL/g | mol/ton |
| Comparative | only raw | 0 | 0 | 292 | 250 | 0.720 | 14.1 |
| Example 6 | material | | | | | | |
| Comparative | no coating | 40 | 0 | 294 | 250 | 0.714 | 14.9 |
| Example 7 | | | | | | | |
| Comparative | Comparative | 40 | 0 | 294 | 250 | 0.712 | 15.5 |
| Example 8 | Example 1 | | | | | | |
| Example 17 | Example 11 | 10 | 25 | 291 | 250 | 0.721 | 13.8 |
| Example 18 | Example 11 | 15 | 40 | 289 | 250 | 0.722 | 13.6 |
| Example 19 | Example 11 | 30 | 77 | 289 | 250 | 0.723 | 13.4 |
| Example 20 | Example 11 | 40 | 100 | 287 | 250 | 0.723 | 13.3 |

The AV values shown in Table 2 are shown in FIG. 2. It is understood from Table 2 and FIG. 2 that the AV values of the films in Examples 17 to 20 were lower than the AV values of the films in Comparative Examples 6 to 8. Furthermore, it is also understood that the IV values of the films in Examples 17 to 20 were higher than the IV values of the films in Comparative Examples 6 to 8.

From the results shown above, it is understood that the polyester film containing the compound that is derived from the acid-modified polyolefin resin suffers less heat deterioration and has good quality.

### INDUSTRIAL APPLICABILITY

According to the invention, a laminated film having a coating layer using a polyolefin resin may be produced by an in-line coating method. Accordingly, the invention may provide a laminated film having excellent adhesion property and water resistance. Furthermore, the laminated film of the invention may be recycled and reused to suppress the cost for producing the laminated film, and thus has high industrial applicability.

### REFERENCE SIGNS LIST

1 polyester film
2 coating layer
3 laminated film

While the present invention has been described in detail and with reference to specific embodiments thereof, it will be apparent to one skilled in the art that various changes and modifications can be made therein without departing from the spirit and scope thereof.

The present disclosure relates to the subject matter contained in International Application No. PCT/JP2013/075075, filed Sep. 18, 2013, and Japanese Patent Application No. 2012-226793 filed on Oct. 12, 2012, the contents of which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims.

What is claimed is:

1. A laminated film containing a polyester film and a coating layer that is laminated on at least one surface of the polyester film,
wherein the coating layer contains an acid-modified polyolefin resin and a basic compound having a boiling point of 200° C. or less, and,
the polyester film contains a compound that is derived from the acid-modified polyolefin resin contained in the coating layer.

2. The laminated film according to claim 1, wherein the compound that is derived from the acid-modified polyolefin resin is contained in an amount of from 10 to 1,000 ppm based on the mass of the polyester film.

3. The laminated film according to claim 1, wherein the coating layer has a thickness of from 0.01 to 1 μm.

4. The laminated film according to claim 1, wherein the acid-modified polyolefin resin has a melt flow rate at 190° C. and a load 2,160 g of from 0.01 to 500 g/10 minutes.

5. The laminated film according to claim 1, wherein the acid-modified polyolefin resin contains an unsaturated carboxylic acid or an anhydride thereof in an amount of from 0.1 to 10% by mass.

6. The laminated film according to claim 5, wherein the unsaturated carboxylic acid or the anhydride thereof is acrylic acid, methacrylic acid, an acrylic anhydride, or a methacrylic anhydride.

7. The laminated film according to claim 1, wherein the acid-modified polyolefin resin contains an unsaturated carboxylate ester in an amount of from 0.1 to 25% by mass.

8. The laminated film according to claim 7, wherein the unsaturated carboxylate ester is a methyl ester of an unsaturated carboxylic acid, an ethyl ester of an unsaturated carboxylic acid, or a butyl ester of an unsaturated carboxylic acid.

9. The laminated film according to claim 1, wherein the acid-modified polyolefin resin is a terpolymer of an ethylene, an unsaturated carboxylate ester, and an unsaturated carboxylic acid; or a terpolymer of an ethylene, an unsaturated carboxylate ester, and an anhydride of an unsaturated carboxylic acid.

10. The laminated film according to claim 1, wherein the acid-modified polyolefin resin is a terpolymer of an ethylene, an acrylate ester, and acrylic acid; a terpolymer of an ethylene, an acrylate ester, and an acrylic anhydride; a terpolymer of ethylene, a methacrylate ester, and acrylic acid; or a terpolymer of ethylene, a methacrylate ester, and an acrylic anhydride.

11. The laminated film according to claim 1, wherein the basic compound is an ammonia or an organic amine compound.

12. The laminated film according to claim 1, wherein the basic compound is contained in an amount of from 0.5 to 3.0 times by molar equivalent based on the molar number of carboxyl groups in the acid-modified polyolefin resin.

13. The laminated film according to claim 1, wherein the polyester film contains a Ti compound.

14. A method for producing a laminated film containing coating a coating solution on at least one surface of a polyester film, and stretching the resultant to form a coating layer,
wherein the coating solution contains a basic compound having a boiling point of 200° C. or less and an acid-modified polyolefin resin, and,
the polyester film contains a compound that is derived from the acid-modified polyolefin resin contained in the coating layer.

15. The method for producing a laminated film according to claim 14, further containing drying before the forming of the coating layer, wherein the drying is heating a resin mixture containing a polyester resin and an acid-modified polyolefin resin.

16. The method for producing a laminated film according to claim 15, wherein the resin mixture contains a recycled film.

17. The method for producing a laminated film according to claim 15, wherein the resin mixture is a mixture of a recycled film and a polyester resin, and,
the recycled film is contained in an amount of from 20 to 80% by mass based on the polyester resin.

18. The method for producing a laminated film according to claim 15, wherein the drying contains drying the resin mixture at from 100 to 200° C.

19. A laminated film produced by coating a coating solution on at least one surface of a polyester film, and stretching the resultant to form a coating layer,
wherein the coating solution contains a basic compound having a boiling point of 200° C. or less and an acid-modified polyolefin resin, and,
the polyester film contains a compound that is derived from the acid-modified polyolefin resin contained in the coating layer.
